(19) United States
(12) Patent Application Publication
(10) Pub. No.: US 2009/0269564 A1
(43) Pub. Date: Oct. 29, 2009

(54) Manufacturing of Nets Consisting of Synthetic Yarns and Monofilament Yarns

(75) Inventor: Antonios Karatzis, Crete (GR)

Correspondence Address: Sean F. Mellino;D. Peter Hochberg Co., 1940 East 6th St., 6th Floor, Cleveland, OH, 44114, US

(73) Assignee: Karatzis S.A. Industrial & Hotelier Enterprises, Heraclion, Crete (GR)

(21) Appl. No.: 12/224,938

(22) PCT Filed: Mar. 9, 2007
(86) PCT No.: PCT/EP2007/002101

§ 371 Date: Apr. 21, 2009

(30) Foreign Application Priority Data
Mar. 9, 2006 (GR) 20060100154

(51) Int. Cl. B32B 5/00; D04H 3/00; D03D 15/08

(52) U.S. Cl. 428/220; 442/50; 139/421; 139/420 A

(57) ABSTRACT

By the extrusion method, (position 1) polyethylene yarns are produced (position 2). These yarns are cooled in a cold water container (position 3). Following that and after having been pre-stretched (position 4), the yarns come into a heating oven (position 5), where they are drawn by shafts (position 6). The monofilament that has been created by the method is then coiled in bobbins (position 8) through an appropriate coiling system (position 9). Following that, the monofilament bobbins are placed on the Raschel knitting machine and are knitted together with polyethylene yarns in latticed fabric. The final product shall be a net utilized for the palletization of various materials. This net has high elasticity, extensibility and breaking resistance.

### CROSS-REFERENCE TO RELATED APPLICATIONS

This application is a National Stage application of International Application No. PCT/EP2007/002101, filed on Mar. 9, 2007, which claims priority of Greek application No. 20060100154, filed on Mar. 9, 2006, both of which are incorporated herein by reference in their entireties.

### BACKGROUND OF THE INVENTION

1. Field of the Invention

The present invention pertains to a net or a netting comprising yarns which are made from a thermally pre-stretched monofilament produced by extrusion of a polyethylene mixture.

2. Description of the Prior Art

Existing nets, used for palletization, mostly consist of pre-stretched and knitted polyolefin yarns, preferably of polyolefin mixtures. This technology results in the production of low quality nets, with low extensibility and breaking resistance and low final elasticity.

For the same reasons, the improvement of the final elasticity necessitates the utilization of various polyethylene mixtures. Accordingly, the final product manufactured becomes uneconomic for large-scale usage.

With the ordinary monofilament production methods employed, the manufacturing of light, knitted nets rendering satisfactory elasticity and breaking resistance, which could be utilized in heavy-weight product packing, such as pallets, packages, etc., is not feasible.

GB-A-2 239 211 discloses a knitted plastic netting made by knitting longitudinal and lateral ribbons. Both longitudinal and lateral ribbons are made from a film material.

WO-A-96 10107 refers to a light reflecting screen made by a net which has a plurality of threads oriented in one direction and being spaced from one another, and having wefts oriented perpendicular to said one direction. The wefts are bands made of a laminate having a first layer consisting of a transparent polymeric film, a second layer on said first layer consisting of aluminium, and a third layer on the second layer consisting of a transparent material.

### SUMMARY OF THE PRESENT INVENTION

It is the object of the present invention to provide for a net or a netting of a high quality.

The object is solved by a netting in accordance with the present invention.

According to the present invention, this object is resolved by a net or a netting comprising yarns which are made from a thermally pre-stretched monofilament produced by extrusion of a polyethylene mixture.

The innovation proposed by the invention makes the production of low purchasing cost, high extensibility and breaking resistance of the palletization net possible. This may be affected by replacing the polyethylene yarns with wide monofilament yarns, which have been extruded and pre-stretched in a heated container. The extrusion and hot drawing process results in round yarns, the material of which is perfectly homogenized. In addition, powerful and balanced tensions develop on monofilament yarn surfaces. These factors result in the production of very thin yarns of high elasticity and breaking resistance.

Advantageous embodiments of the invention are discussed in more detail below.

Preferably, the net or the netting comprises at least one meshed material made of a plurality of yarns which consist of warps that are made from a thermally pre-stretched monofilament produced by extrusion of a polyethylene mixture and of filling wefts made from a pre-stretched membrane that is made of a polyethylene mixture.

In a preferred embodiment, the composition of the net or the netting consists of a polyolefin combination, wherein the at least one layer is made of or contains a polyethylene (PE), especially high-low density polyethylene, preferably polyamide (PA), as well as of polyolefin low density (LLDPE) or high density (HDPE) polyethylene and/or a stressed polyethylene film, polypropylene (PP), polyvinylchloride (PVC), or ethylene vinyl acetate (EVA) or at least another similar plastic material or a combination with materials such as a polycarbonic material, as well as of another polyolefin.

Further, the invention pertains to a net or a netting wherein the net or netting comprises a color or a color mixture.

Preferably, the warps consist of a monofilament of chain-knitted monofilament yarns.

In another preferred embodiment, the remaining elasticity of palletization nets ranges from 80 to 120% and its drawing resistance ranges from 35 to 42 kg/m.

According to an advantageous embodiment of the invention, the wefts are made from a polyethylene foil that are cut in strips and stretched thereafter by a thermal treating.

Preferably, the wefts are cut from the foil in strips of about 4.5 mm in width that are stretched to form strips of about 1 to 1.5 mm in width.

Advantageously, the width of the net or the netting ranges from 0.3 to 7 m and its length does not exceed the 4 km.

In a preferred embodiment, the yarns have a thickness in the range of 18 to 240 μm.

Preferably, the net or the netting comprises yarns having a cross-section in the range of 13 to 150 μm.

Further, the present invention pertains to a process of producing a yarn suitable for a net or netting according to any of the preceding claims wherein the yarn is thermally processed in a hot air heating oven.

In an advantageous realization, the process comprises parallel knitting of monofilament warps with wefts produced from cut and pre-stretched polyethylene strips.

The process may be realized such that the warps are stretched in a heating oven at a temperature of more than 100° C., particularly at 105° C. Preferably, the yarns are produced at a thickness from 1 to 6 mm. The yarns may be produced with a cross-section from 13 to 150 μm.

Further, the present invention is related to a heating oven for stretching monofilament yarns by thermal treatment of the yarns wherein the heating oven comprises a plurality of rollers temperated a high temperature.

Advantageously, the heating oven comprises rollers that have a temperature of more than 100° C.

In a preferred embodiment, the rollers following each other in the production direction of the oven are driven at an increasing rotational velocity.

### BRIEF DESCRIPTION OF THE DRAWINGS

Hereinafter, the invention is described in more detail by the drawings wherein:

FIG. 1 shows a schematic side view of a production line for producing monofilament yarns,

FIG. 2a is a perspective view on the end of a reel of meshed material of polyolefine yarns,

FIG. 2b is an enlarged detail of FIG. 2a (letter L in FIG. 2a), and

FIG. 2c is an enlarged detail of FIG. 2b (letter M in FIG. 2b).

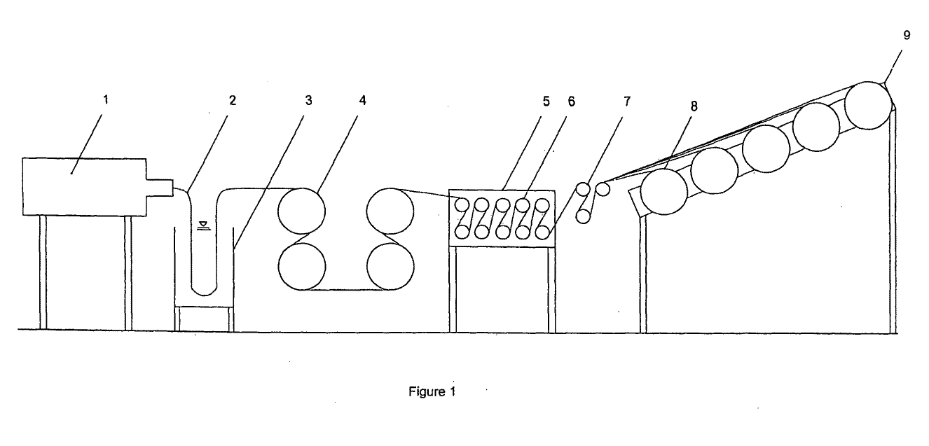

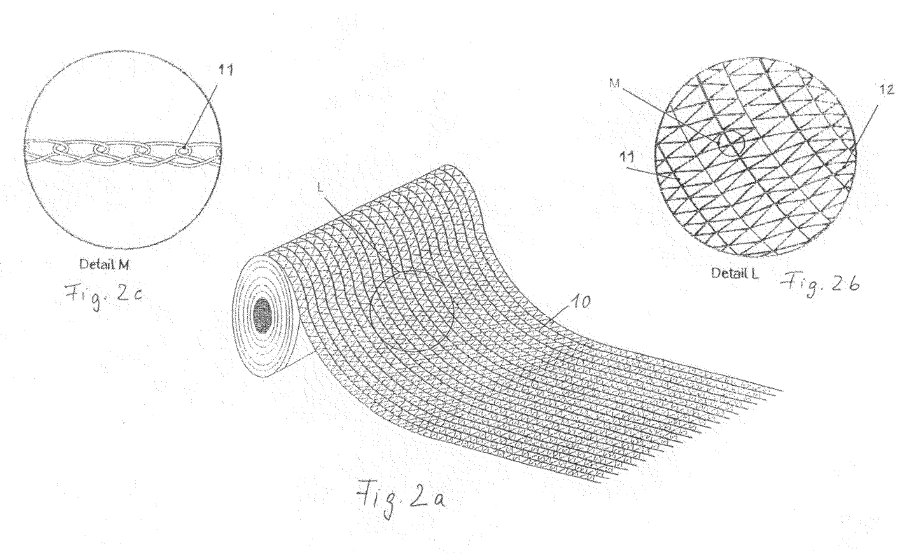

From now on, yarns shall be characterized as follows:
i. {Monofilament}: Round, pre-stretched and stabilized yarns (FIG. 1, pos. 2) made by direct polyethylene extrusion (FIG. 1, pos. 1).
ii. {Strips}: Yarns derived from cut and pre-stretched parallelogram polyethylene strip {FIG. 1, pos. 2).
iii. {Warps}: Monofilament yarns, knitted in chains, oriented to the net flow direction (FIG. 2b, pos. 11).
iv. {Filling wefts}: Zigzag knitted yarns connecting warps into net (FIG. 2b, pos. 12).

### DETAILED DESCRIPTION OF THE PRESENT INVENTION

### Method

This innovation is based on the production of very thin and strong yarns based on polyethylene mixtures, which may be knitted into a net.

In order to avoid the raveling, known from the yarns and nets produced in a conventional process, as explained above, an additional innovation proposed in the series of these new products is the parallel knitting of monofilament yarns produced by polyethylene extrusion.

The extrusion apparatus comprises an extrusion section, the drawing section and the coiling section. At first, polyethylene is being extruded in an extruder 1 (FIG. 1). Following that, polyethylene yarns 2 are formed, which come into a cold water container 3 for fixing purposes.

After the initial fixing, the yarns are put in a heating oven, into which the final monofilament drawing and fixing are affected by a large number of rotating rollers 4 forming a drawing system. The number and the speed of the rollers 4 may be chosen freely and defined solely by the polyethylene mixture, the thickness of the yarns and their physical attributes (i.e., elasticity, breaking resistance of the yarn to be knitted). Once the monofilament yarns have been stretched, they shall come into a hot air oven 5 comprising rollers 6. Instead of heating the rollers 6 by hot air, the rollers 6 may comprise a filament heating, i.e., a heating by electrical resistance. The oven 5 may have a length of 3 m or more. Rollers 7 draw the yarns during the final drawing stage.

The yarns are coiled in bobbins 8 by a coiling system 9. The yarns produced by said method are placed in a knitting machine in a way that:
the warps are made from monofilament yarns; and
the filling wefts are from pre-stretched polyethylene yarn.

A specific net 10 (FIG. 2a) is made from warps 11 (FIG. 2b, c), which consist of a monofilament having a diameter of 18 μm, resulting in a weight of approximately 40 kg and a high elasticity ranging almost at 100%. The selection of this particular number of warps 11 has been made on the basis of the particular usage, for which the net 10 is intended. The yarns of these nets 10 may be produced at any thickness, preferably from 1 to 6 mm. The polypropylene line, in particular, may be produced at any cross-section, preferably from 13 to 150 μm, thus changing the physical attributes of the net 10.

The series of these nets 10 may be produced at any width, preferably from 0.38 to 2 m. As regards the length of the net 10, this is defined solely by the usage for which the final product is intended. Consequently, from the aforementioned dimensions the remaining elasticity of the net 10 may be found to range from 80 to 120%. Therefore, the net 10 extensibility shall range from 35 to 42 kg/m. The knitting pattern and color are free; they are also defined by the usage of the final product (FIG. 2a).

Said innovations result in the production of a series of new products (FIG. 2a -c), which demonstrate high elasticity and breaking resistance. Accordingly, these products hold strongly on the materials to be packed. As an example, we shall refer to one of the products of this new series, such as the net 10, for instance, used for stabilization and security of palletized products. An additional advantage of this net 10 is the fact that following its stabilization on the packed product, it can be easily removed and disposed.

In FIG. a-c, the final product prior to its final packing is depicted. This is a representative form of the final net 10 with strengthening monofilament yarns. In FIG. 2b, warps 11 of the net 10 are shown. Furthermore, in position 12 of FIG. 2b one of the filling wefts of the net 10 is shown. FIG. 2c shows the warps 11 of the net, which are knitted in the form of a chain 11.

By the extrusion method according to the present invention, polyethylene yarns are produced. These yarns are cooled in a cold water container 3. Following that and after having been pre-stretched by rollers 4, the yarns come into a heating oven 5, where they are drawn by rollers 6.

The monofilament that has been created by said method is then coiled in bobbins 8 through an appropriate coiling system 9. Following that, the monofilament bobbins 8 are placed on the Raschel knitting machine and are knitted together with polyethylene yarns in latticed fabric. The final product shall be a net 10 utilized for the palletization of various materials (FIG. 2a-c). This net has high elasticity, extensibility and breaking resistance.

The combination of materials utilized in yarn and monofilament production is free, defined solely by the usage for which the final product is intended. Chain-knitted monofilament yarns produced in an apparatus according to the present invention (FIG. 1) demonstrate a high surface tension; in particular, they have a high elasticity and expansibility resistance. The yarns may be produced in any width and length, defined only by the usage for which the final product is intended.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

1. Net or netting comprising a meshed material made by knitting of a plurality of
warps that are made from a thermally pre-stretched monofilament produced by extrusion of a polyethylene mixture and knitted in the form of a chain; and of
filling wefts made from a cut pre-stretched membrane that is made of a polyethylene mixture.

2. The net or netting according to claim 1, wherein the composition of the net or the netting consists of a polyolefin combination, wherein the at least one layer is made of or contains a polyethylene (PE), especially high-low density polyethylene, preferably polyamide (PA), as well as of polyolefin low density (LLDPE) or high density (HDPE) polyethylene and/or stressed polyethylene film, polypropylene (PP), polyvinylchloride (PVC), or ethylene vinyl acetate (EVA) or at least another similar plastic material or a combination with materials such as a polycarbonic material, as well as of another polyolefin.

3. Net or netting according to claim 1, wherein the net or netting comprises a color or a color mixture.

4. The net or netting according to claim 1, wherein the warps consist of a monofilament of chain-knitted monofilament yarns.

5. The net or netting according to claim 1, wherein the wefts are made from a polyethylene foil that is cut in strips and subsequently stretched by a thermal treating.

6. The net or netting according to claim 5, wherein the wefts are foil strips comprising a width in the range of about 1 to 1.5 mm.

7. The net or netting according to claim 1, wherein the net or netting comprises a width in the range from 0.3 to 7 m and comprises a length not exceeding the 4 km.

8. The net or netting according to claim 1, claims wherein the wefts have a thickness in the range of 18 to 240 μm.

9. The net or netting according to claim 1, wherein the monofilaments have a cross-section in the range of 13 to 150 μm.

10. A process of producing a net or netting by parallel knitting of monofilament warps, which consist of chain-knitted monofilament yarns, with wefts produced from cut and pre-stretched polyethylene strips.

11. The process according to claim 10, comprising the step of stretching the warps in a heating oven at a temperature of more than 100° C.

12. The process according to claim 10, further comprising the step of cutting the wefts from a polyethylene foil in strips of about 4.5 mm in width that are stretched to form strips of about 1 to 1.5 mm in width.

13. The process according to claim 11, comprising the step of stretching the warps in a heating oven at a temperature of at least more than 105° C.
